(19) United States
(12) Patent Application Publication
(10) Pub. No.: US 2007/0235483 A1
(43) Pub. Date: Oct. 11, 2007

(54) Selectively openable article holder

(76) Inventor: Heather Konet, Canton, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/391,055

(22) Filed: Mar. 28, 2006

(51) Int. Cl. B60R 7/00

(52) U.S. Cl. 224/275; 224/282

(57) ABSTRACT

An embodiment provides a article carrying device that includes an inner panel and a generally rigid outer panel. The outer panel is defined in part by an upper edge and a lower edge. The inner panel is hingedly coupled to the back panel proximal to the lower edge. The outer panel is rotatable between a closed position wherein the inner panel and the outer panel are substantially coplanar and an open position wherein the outer panel is angled with respect to the inner panel. The device includes a stay member interconnecting the inner panel and the outer panel. The stay member is operable to retain the outer panel in the open position. The device further includes a flexible liner member coupled to the inner panel and the outer panel. The flexible liner member defines an arcuate article carrying surface therebetween when the outer panel is in the open position.

### TECHNICAL FIELD

The present invention generally relates to storage devices, and more particularly to storage devices within an automobile.

### BACKGROUND

A number of portable article carrying devices have been disclosed in the art. These devices have been designed and constructed for support of a myriad of items and for a plurality of applications. The items include beverages, books, newspapers, purses, and small personal items. The devices generally restrict the motion of an item with the conveyance thereof. It is not uncommon for such devices to have designs adapted specifically for a primary article support application. For example, shopping basket support assemblies have included configured plate assemblies adapted for interengaging the orthogonal frame basket members in a fashion facilitating stability of the configured plate.

More recent developments include storage compartments in various locations of a vehicle. However, these locations may not be readily accessible to a user, or may interfere with other uses of the vehicle if the item is stored in a location of frequently used space. Many soft, delicate, or fragile items may be stored on an unused seat of a vehicle if unused space is available. Items such as purses or briefcases with decorative and/or easily marred surfaces may not be desirably stored on a floor or a seat of an automobile, since the items may move and collide with other items within the vehicle during normal vehicle operation. It may be an encumbrance for the operator to also deal with loose articles such as purses, laptops, sweaters, sunglasses, or infant care articles while riding in a vehicle.

Additionally, many storage locations for items, such as handbags and/or briefcases, may include relatively hard projections that may mar or dent the surface of the item. These projections may damage the outer surface of the item by directing an undesired concentrated force on the item during acceleration events (starting, stopping, turning) while the vehicle is traveling. Furthermore, many potential storage locations for delicate items may be capable of supporting additional items, thereby encouraging one to place heavy or sharp items on or in contact with the delicate item.

Accordingly, a need exists for a storage device within a vehicle that will provide a dedicated location for items such as handbags and briefcases, and/or permit delicate items to be segregated from other items.

### SUMMARY

An embodiment provides an article carrying device that includes an inner panel and a generally rigid outer panel. The outer panel is defined in part by an upper edge and a lower edge. The inner panel is hingedly coupled to the back panel proximal to the lower edge. The outer panel is rotatable between a closed position wherein the inner panel and the outer panel are substantially coplanar and an open position wherein the outer panel is angled with respect to the inner panel. The device includes a stay member interconnecting the inner panel and the outer panel. The stay member is operable to retain the outer panel in the open position. The device further includes a flexible liner member coupled to the inner panel and the outer panel. The flexible liner member defines an arcuate article carrying surface therebetween when the outer panel is in the open position.

Another illustrative embodiment includes a storage device for a vehicle seat having a seat outer surface portion. The device includes a body portion having an upper edge, a lower edge, a first edge, and a second edge. The device also includes a flexible inlay portion having a support surface, a bottom surface, proximal edge, a distal edge, a first lateral edge, and a second lateral edge. The device extends between the body portion and the seat outer surface portion. The inlay portion is coupled to a portion of the body portion and to the seat outer surface portion. The body portion is moveable between a first position, where at least a portion of the body portion is generally parallel to the seat outer surface portion, and a second position, where at least a portion of the inlay portion is selectively deformed into an arcuate support surface between the proximal edge and the distal edge.

A further exemplary embodiment provides a support device for storing an article adjacent a selected surface portion. The support device includes a body portion having an upper edge, a lower edge, a first edge, a second edge. The body portion is moveable between a first position, where at least a portion of the upper edge positioned a first distance from the selected surface portion, and a second position, where the at least a portion of the upper edge is selectively positioned a second distance from the selected surface portion. The support device also includes a hinge portion rotatably coupling the body portion to the selected surface portion. The body portion is rotatable generally about the hinge portion. The support device further includes an inlay portion extending between the body portion and the selected surface portion. The inlay portion is coupled to a portion of the body portion and to the selected surface portion. The inlay portion is defined, at least in part, by a gripping surface portion.

### BRIEF DESCRIPTION OF THE DRAWINGS

Referring now to the drawings, preferred illustrative embodiments are shown in detail. Although the drawings represent some embodiments, the drawings are not necessarily to scale and certain features may be exaggerated, removed, or partially sectioned to better illustrate and explain the present invention. Further, the embodiments set forth herein are not intended to be exhaustive or otherwise limit or restrict the claims to the precise forms and positions shown in the drawings and disclosed in the following detailed description.

FIG. 1 is a perspective view of an embodiment of a storage system.

FIG. 2 is a perspective view of an embodiment of a storage device.

FIG. 3 is a side view of the storage device of FIG. 2 in an operational, or open, position.

FIG. 4 is a side view of the storage device of FIG. 2 in a stowed, or closed, position.

FIG. 5 is a front view of a portion of the storage device of FIG. 2.

FIG. 6 is a perspective view of an embodiment of a storage system.

FIG. 7 is a perspective view of an embodiment of a storage system.

### DETAILED DESCRIPTION

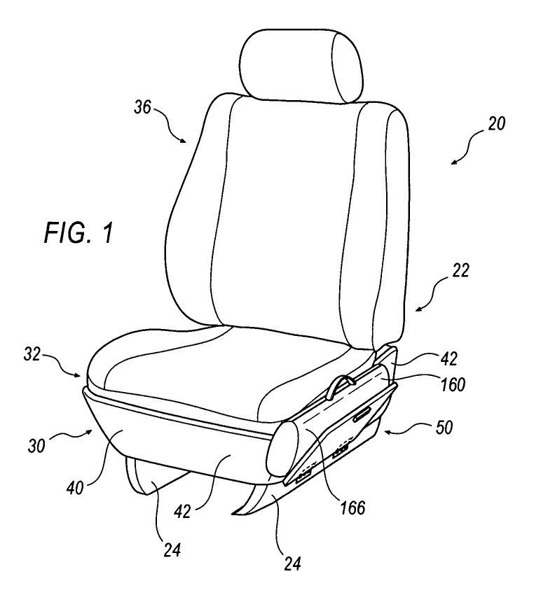

FIG. 1 illustrates an article holder storage system 20. System 20 includes a seat 22 connected to a vehicle (not shown) by a seat frame 24. Seat 22 includes a seat base 30, a bolster 32, and a seat back 36. Seat base 30 may include trim panels 40 having an outer surface portion 42 that at least partially cover the seat frame 24. System 20 further includes a support device 50.

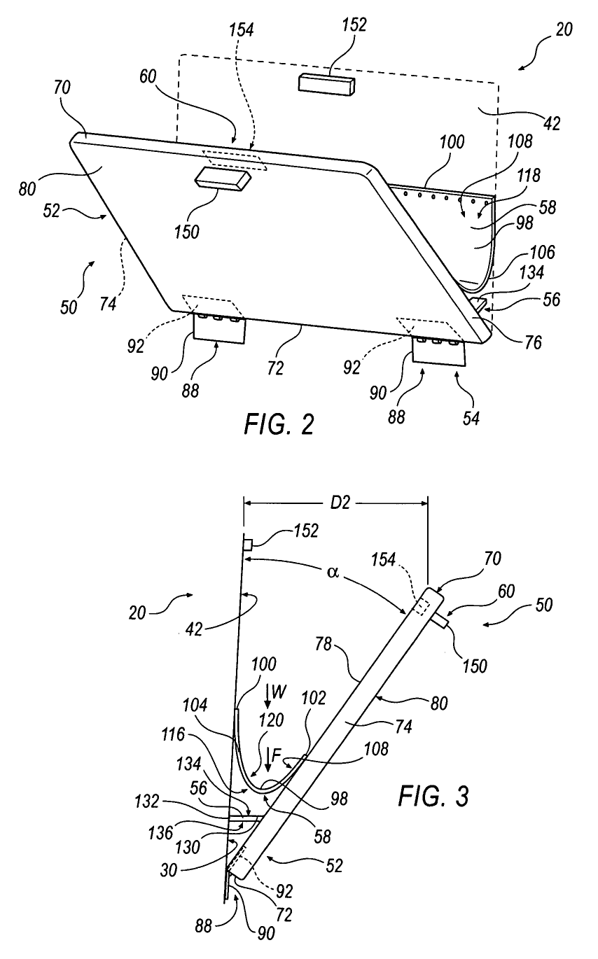

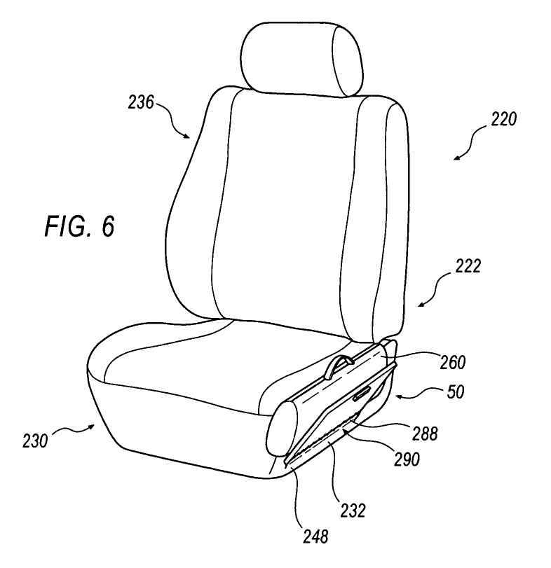

Support device 50, as illustrated in detail in FIGS. 2-5, includes an outer panel, or body portion, 52, a hinge portion 54, a stay member 56, an inlay portion, or liner member 58, and a latching portion 60. Body portion 52 includes an upper edge 70 and a lower edge 72, generally defining a height H therebetween (as best seen in FIG. 5); a first edge 74 and a second edge 76, generally defining a length L therebetween (also as best seen in FIG. 5); an inner surface 78; and an outer surface 80.

As best seen in at least one of FIGS. 2-5, hinge portion 54 includes at least one hinge 88 that each include a mounting portion 90 rotatably coupled to a tab portion 92. In one embodiment, hinge portion 54 includes a pair of hinges 88. Mounting portion 90 is attached to the seat base 30 and tab portion 92 is attached to the body portion 52. Hinge portion 54 permits body portion 52 to rotate relative to the seat base 30.

Inlay portion 58 is attached to and extends between the inner surface 78 and the outer surface portion 42. Inlay portion 58 includes a generally planar, flexible body 98 defined by a proximal edge 100, a distal edge 102, a first lateral edge 104, a second lateral edge 106, a top, or support, surface 108, and a bottom surface 110. In the operational position of FIG. 3, at least a portion of body 98 is defined by an arcuate article carrying, or support, portion 116, where at least a portion of top surface 108 is defined by an arcuate article carrying, or support, surface 118. At least a portion of top surface 108 includes a gripping surface portion 120. Proximal edge 100 is attached to the outer surface portion 42. Distal edge 102 is attached to inner surface 78.

Stay member 56 includes a first end 130, a second end 132, a first surface 134, and a second surface 136. First end 130 of stay member 56 is attached to the inner surface 78 and second end 132 of stay member 56 is attached to the seat base 30. Accordingly, the stay member 56 extends between the body portion 52 and the seat 22.

When the body portion 52 is in the operational position, the weight of the body portion 52 will generally retain the body portion 52 in the operational position, thus exerting a slight tensile force on the stay member 56. Stay member 56 restricts rotation of the body portion 52 relative to the seat 22. Preferably, the stay member 56 retains the body portion 52 at an angle α of between about 30 and 40 degrees relative to the outer surface portion 42, although angle α may be any suitable acute angle.

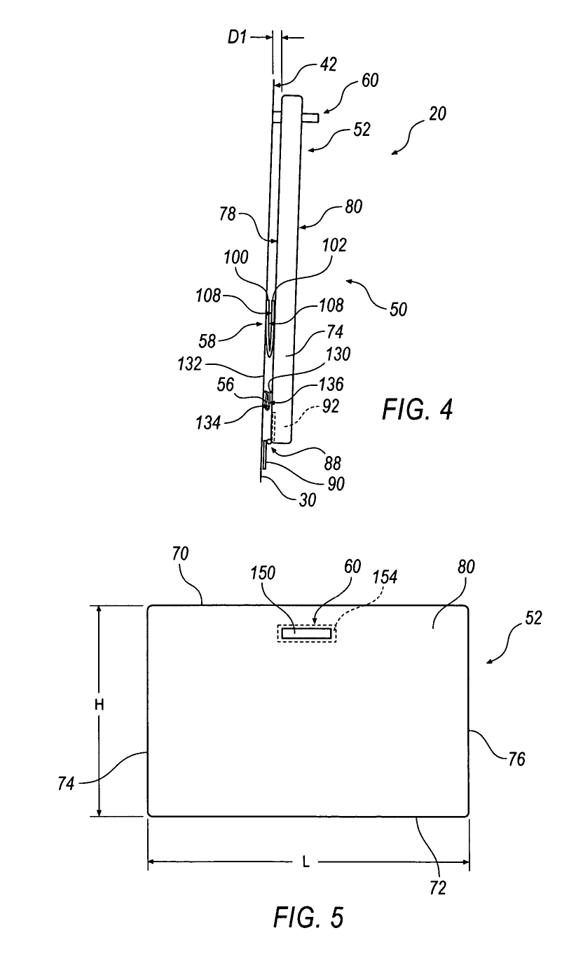

Preferably, stay member 56 is a flexible strap that folds when the body portion 52 is in a stowed position, (FIG. 4) and resists a tensile force to retain the body portion 52 in a desired position when the support device 50 is in an operational position, (FIG. 3). In the embodiment illustrated, a portion of the first surface 134 contacts another portion of the first surface 134, when the stay member 56 is folded, as seen in FIG. 4. Alternatively, a portion of the second surface 136 contacts another portion of the second surface 136.

Latching portion 60 includes a handle 150, a magnet 152, and a magnetic recess 154 formed in the inner surface 78. The magnet 152 is attracted to the magnetic recess 154 by a magnetic force. When the body portion 52 is in the stowed position, the magnet 152 is interposed in the magnetic recess 154. The magnet 152 of latching portion 60 restrains the body portion 52 in about the stowed position until a user desires to move the body portion 52 relative to other components of the system 20.

As illustrated in FIG. 1, the system 20 supports a storage item 160. The storage item 160 has an item surface 166 that contacts the gripping surface portion 120 and/or the support surface 108 to retain the storage item 160 within the system 20 and to resist generally horizontal forces imposed on the storage item 160 during vehicle movement. In the stowed position, the upper edge 70 is positioned a first distance D1 from the outer surface portion 42, as best seen in FIG. 4. In the operational position, the upper edge 70 is positioned a second distance D2 from the outer surface portion 42, as best seen in FIG. 3.

When the body portion 52 is in about the stowed position of FIG. 4, inlay portion 58 is folded such that at least one of the proximal edge 100 and the distal edge 102 selectively contacts a portion support surface 108. Also when the body portion is in about the stowed position, the inlay portion is selectively folded such that a portion of the support surface 108 contacts another portion of the support surface 108.

In the embodiment illustrated in FIGS. 2 and 3, inlay portion 58 is neither fully folded (FIG. 4) nor fully unfolded when the device 50 is in the operational position. That is, the gripping surface portion 120 of inlay portion 58 forms an arcuate article carrying surface, or arcuate support surface, when the device 50 is in the operational position. Additionally, as an item, such as the storage item 160, is placed into contact with the inlay portion 58, the weight of the item, represented by the arrow W in FIG. 3, exerts a force F on the inlay portion 58. The force F, which is the weight W of the item when the vehicle is stationary, will tend to displace a portion of the inlay portion 58 in the direction of arrow F, thereby reducing the distance from the upper edge 70 of the body portion 52 to the outer surface portion 42 to less than distance D2. As the distance between the upper edge 70 and the outer surface portion 42 is reduced, the inlay portion 58 will deform to mate with the item surface 166 of storage item 160, to increase the contact area between the inlay portion 58 and the storage item 160 while decreasing the surface pressure of any initial contact points between the inlay portion 58 and the item surface 166. Accordingly, at least a portion of the inlay portion 58 deforms to an arcuate shape that cradles an item, such as storage item 160, as a function of the weight W of the item.

As the vehicle moves, the storage item 160 is permitted to move slightly within the device 50. Specifically, as a component of the vehicle travel results in downward movement, generally in the direction of arrow F, the acceleration in the direction of the arrow F will result in the force F being less than the weight W. Accordingly, the storage item 160 may move slightly relative to the vehicle, in a direction generally opposite the arrow F. Unlike other storage support surfaces, at least portions of the support surface 108 will travel with the storage item 160, as the item surface 166 remains in contact with the support surface 108 and/or the gripping surface portion 120. In this manner, the frictional forces that retain the storage item 160 within the device 50 may not be reduced to a value below the required frictional forces that retain the storage item 160 within the device 50.

Furthermore, as the component of the vehicle travel that resulted in downward movement is reduced, or as a component of the vehicle travel results in upward movement, generally opposite the direction of arrow F, the acceleration component opposite the direction of the arrow F will result in the force F being more than the weight W. With conventional surfaces that support an item while not moving relative the vehicle, such as the floor of the vehicle, this additional force exerted on the storage item will result in a generally proportional increase in force on the items that may be stored within the storage item 160. However, when an item is stored on the device 50, when the force F increases to a value more than the weight W, the inlay portion 58 may further deform resulting in the body portion 52 rotating relative the seat 22. As the inlay portion 58 further deforms as described, the storage item 160 moves slightly, generally in the direction F relative the vehicle, which may be generally opposite the travel of the vehicle. After the component of the vehicle travel generally opposite the direction of the arrow F decreases or reduces to zero, the force F becomes generally equal the weight W, and the storage item 160 will travel generally opposite the direction of the arrow F. Accordingly, as a component of the vehicle travel generally opposite the direction of the arrow F is experienced, such as when the vehicle travels over a non-horizontal road surface portion, the hinge portion 54 of the device 50 travels a distance component measured along the direction of arrow F in a period of time T1, while the storage item 160 will travel generally the same distance in a longer time, T2. Accordingly, the device 50 increases the time of horizontal travel of the storage item 160 relative to the vehicle as a result of operating the vehicle on non-horizontal road surfaces, thereby damping the accelerations that the storage item 160 will experience during vehicle travel. Additionally, when the device 50 is mounted to a portion of the vehicle with a spring support, such as a seat 22, the damping effect that may exist in the springs of the seat 22 will further dampen the accelerations translated from the vehicle to the storage item 160, while retaining the storage item 160 within the device 50. As will be appreciated, the device 50 will similarly dampen the accelerations of the storage item 160 in directions normal to the arrow F due as a result of the flexibility of the inlay portion 58.

Preferably, gripping surface portion 120 has a higher coefficient of friction than a surface portion of the body portion 52. The gripping surface portion 120 may be formed by an overlay material that is attached to the inlay portion 58, or the gripping surface portion 120 may be a surface portion of the inlay portion 58 support surface 108 that contacts a desired item, such as the storage item 160.

One embodiment of utilizing the system 20 is as follows. With the device 50 in the stowed position of FIG. 4, a user may grasp the handle 150 and pull the magnet 152 away from the magnetic portion 154. As the magnet 152 moves away from the magnetic portion 154, the body portion 52 rotates about the hinge portion 54. When the user releases the handle 150, at least the weight of the body portion 52 will retain the device 50 in about the operational position. In the operational position, the device 50 may be used, as described herein. When the user no longer desires to use the device 50, the body portion 52 may be rotated until magnet 152 contacts the magnetic portion 154.

FIG. 6 illustrates an alternative embodiment of the storage system 20 as storage system 220. System 220 includes a seat 222 connected to a vehicle body (not shown) by a seat frame 224. Seat 222 includes a seat base 230, a bolster 232, and a seat back 236. Preferably, the bolster 232 has a fabric outer layer 248, such as woven fibers, vinyl, leather, or the like. As illustrated, system 220 selectively supports and/or retains a support item 260.

System 220 further includes the support device 50 attached thereto with an alternative embodiment of the hinges 88 as a hinge 288. The hinge 288 includes a plurality of stitches 290 that each interconnect the body portion 52 to the bolster 232.

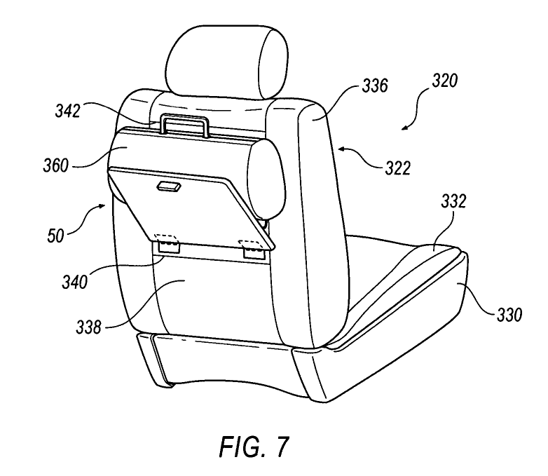

FIG. 7 illustrates an alternative embodiment of the storage system 20 as storage system 320. System 320 includes a seat 322 connected to a vehicle body (not shown) by a seat frame 324. Seat 322 includes a seat base 330, a bolster 332, and a seat back 336 having a seat outer surface 338. System 320 further includes a support device 50 having an inner panel 340. Inner panel 340 is attached to the seat outer surface 338. Inner panel 340 has an outer surface portion 342. As illustrated, system 320 selectively supports and/or retains a support item 360.

The outer surface portion 342 of inner panel 340 is connected to the hinge 88, the stay member 56, and the magnet 152. The magnet 150 may extend from, or be embedded such that the magnet is flush with, a surface, such as outer surface portion 342. In the embodiments illustrated, support device 50 is defined by a generally planar outer surface 80 while the inner surface 78 contours to the seat outer surface 338 and outer surface portion 342.

While hinges 88, 288 are described as including multiple components, the hinge portions may be any connection between the body portions and a selected mounting surface that permits the body portion to move relative the selected surface. Non-limiting examples include a pantograph linkage and bendable portions of body portion 52. Additionally, Systems 20, 220, 330 may not include a hinge, but may permit the stay member 56 to restrain the body portion 52 in a desired position, such as the operational position, when an item is stored on the inlay portion.

Systems 20, 220, 330 may not include a stay member 56, but may have a hinge portion, such as the hinge portion 54, that restricts the rotation of the body portion to a desired position, such as the operational position of FIG. 3. While the device 50 is described herein as mounted to a seat of an automobile, the device 50 may be mounted to other components and/or surfaces.

The inlay portion 58 may be a fabric with a rubbery finish, a sheet of TPV, TPE, rubbery foam, leather or suede. Also, the inlay portion 58 may be perforated or in the form of a netting.

In the embodiments illustrated, the body portion 52 is defined by a generally planar contour of surfaces 78, 80, although the body portion 52 may alternatively have a curvilinear contour. Additionally, the body portion may be made of polypropylene, ABS, polycarbonate, nylon, or any suitable material. The outer surface 80 of body portion 52 may also be covered in a complementary or contrasting material, as desired, such as leather or fabric. If the outer surface 80 is covered in a material, such as leather, the stitches 290 may pierce the leather to provide the hinge 288. The body portion 52 is preferably a rigid panel, although the body portion 52 may be flexible, and may be about 3 mm in thickness between surfaces 78 and 80 when the length L of the body portion is about 250 mm and the height H is about 200 mm.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. An article carrying device for a vehicle comprising:
an inner panel;
a generally rigid outer panel defined in part by an upper edge and a lower edge, the inner panel hingedly coupled to the outer panel proximal to the lower edge, the outer panel rotatable between a closed position wherein the inner panel and the outer panel are substantially coplanar to an open position wherein the outer panel is angled with respect to the inner panel;
a stay member interconnecting the inner panel and the outer panel, the stay member operable to restrain the outer panel in about the open position; and
a flexible liner member coupled to the inner panel and the outer panel, the flexible liner member defining an arcuate article carrying surface therebetween when the outer panel is in the open position.

2. The device of claim 1, wherein the liner member has a gripping surface portion for selectively retaining the article relative to at least a portion of the device.

3. The device of claim 2, wherein the gripping surface portion has a higher coefficient of friction than a surface portion of the outer panel.

4. The device of claim 1, further comprising a latching portion to restrain the outer panel in about the closed position.

5. The device of claim 1, further comprising a hinge portion attached adjacent the lower edge of the outer panel and the inner panel, wherein the hinge selectively permits the outer panel to rotate relative to the inner panel.

6. The device of claim 1, wherein the liner member includes a proximal edge and a distal edge, and the liner member is selectively folded such that at least one of the proximal edge and the distal edge selectively contacts a portion of the article carrying surface when the outer panel is in about the closed position.

7. The device of claim 1, wherein the stay member includes a first surface and a second surface, and the stay member is selectively folded when the outer panel is in the closed position, such that a portion of the first surface contacts another portion of the first surface.

8. A storage device for a vehicle seat having a seat outer surface portion, the device comprising:
a body portion having an upper edge, a lower edge, a first edge, and a second edge; and
a flexible inlay portion having a support surface, a bottom surface, proximal edge, a distal edge, a first lateral edge, and a second lateral edge and extending between the body portion and the seat outer surface portion, wherein the distal edge is coupled to a portion of the body portion and the proximal edge is coupled to a portion of the seat outer surface portion, the body portion is moveable between a first position, where at least a portion of the body portion is generally parallel to the seat outer surface portion, and a second position, where at least a portion of the inlay portion is selectively deformed into an arcuate support surface between the proximal edge and the distal edge.

9. The device of claim 8, wherein the surface contact between a storage item and the inlay portion is selectively increased during vehicle movement as a result of rotation of the body portion relative to a portion of the inlay portion.

10. The device of claim 8, further comprising a hinge portion attached adjacent to the lower edge of the outer panel and to the seat outer surface portion, wherein the hinge selectively permits the body portion to rotate relative to the seat outer surface portion.

11. The device of claim 8, further comprising a stay member to selectively restrict movement of at least a portion of the body portion relative to the seat outer surface portion.

12. The device of claim 8, wherein the inlay portion is defined, at least in part, by a gripping surface portion.

13. The device of claim 12, wherein the gripping surface portion is formed by an overlay material attached to at least portions of the support surface.

14. The device of claim 8, wherein the inlay portion is folded such that at least one of the proximal edge and the distal edge selectively contacts a portion of at least one of the top surface and the bottom surface, when the body portion is in about the first position.

15. The device of claim 8, further comprising a latching portion to restrain the body portion in about the first position.

16. A support device for storing an article adjacent a selected surface portion comprising:
a body portion having an upper edge, a lower edge, a first edge, a second edge, wherein the body portion is moveable between a first position, where at least a portion of the upper edge positioned a first distance from the selected surface portion, and a second position, where the at least a portion of the upper edge selectively positioned a second distance from the selected surface portion;
a hinge portion rotatably coupling the body portion to the selected surface portion, wherein the body portion is rotatable generally about the hinge portion; and
an inlay portion extending between the body portion and the selected surface portion, wherein the inlay portion is coupled to a portion of the body portion and to the selected surface portion, and the inlay portion is defined, at least in part, by a gripping surface portion.

17. The device of claim 16, further comprising a stay member to selectively restrict movement of at least a portion of the body portion relative to the selected surface portion.

18. The device of claim 16, wherein the hinge portion restricts the rotation of the body portion when the body portion is in about the second position.

19. The device of claim 16, wherein the body portion is defined, at least in part, by a generally planar contour.

20. The device of claim 16, wherein the inlay portion is folded such that at least one of the proximal edge and the distal edge selectively contacts a portion of at least one of the top surface and the bottom surface, when the body portion is in about the first position.
